(19) United States
(12) Patent Application Publication
(10) Pub. No.: US 2017/0366766 A1
(43) Pub. Date: Dec. 21, 2017

(54) IMAGE SENSORS HAVING HIGH DYNAMIC RANGE FUNCTIONALITIES

(71) Applicant: SEMICONDUCTOR COMPONENTS INDUSTRIES, LLC, Phoenix, AZ (US)

(72) Inventors: Tomas GEURTS, Haasrode (BE); Manuel INNOCENT, Wezemaal (BE)

(73) Assignee: SEMICONDUCTOR COMPONENTS INDUSTRIES, LLC, Phoenix, AZ (US)

(21) Appl. No.: 15/184,458

(22) Filed: Jun. 16, 2016

(51) Int. Cl. H04N 5/355; H04N 5/353; H04N 5/372; H04N 5/378

(52) U.S. Cl. CPC H04N 5/35581; H04N 5/378; H04N 5/3532; H04N 5/372

(57) ABSTRACT

The image sensor pixel may include a photodiode, a charge storage region, readout circuitry, and a transfer transistor that couples the photodiode to the charge storage region. The photodiode may generate first and second image signals during first and second exposure periods, respectively. The transfer transistor may transfer the first image signal to the charge storage region. While generating the second image signal, the readout circuitry may perform readout operations on the first image signal. Thereafter, the charge storage region may be reset to a reset voltage level. The readout circuitry may perform readout operations on the reset voltage level. Then, transfer transistor may transfer the second image signal to the charge storage region. The readout circuitry may perform readout operations on the second image signal. The readout operations on both the first and second image signals may be double sampling readouts.

### BACKGROUND

This relates generally to imaging devices, and more particularly, to imaging devices having image sensor pixels with high dynamic range functionalities.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Typical image pixels contain a photodiode for generating charge in response to incident light. Image pixels may also include a charge storage region for storing charge that is generated in the photodiode. Image sensors can operate using a global shutter or a rolling shutter scheme. In a global shutter, every pixel in the image sensor may simultaneously capture an image, whereas in a rolling shutter each row of pixels may sequentially capture an image.

Image sensors may be equipped with multi-exposure high dynamic range (HDR) functionality, where multiple images are captured with an image sensor at different exposure times. The images are later combined into a high dynamic range image. An HDR image sensor can operate using a rolling shutter operation. In conventional HDR image sensors, a long-exposure image may be sampled during a first readout cycle. Line buffers are then typically used store the long-exposure image. While the line buffers store the long-exposure image, a short-exposure image is generated. The short-exposure image is then sampled in a second readout cycle. After the short-exposure image is sampled, the short-exposure image and the long-exposure image are combined to form an HDR image. However, the line buffers may add additional costs to manufacturing the image sensor. Additionally, in standard HDR image sensor pixels, bright scenes can cause unwanted saturation of the photodiode leading to over saturated image signals.

It would therefore be desirable to be able to provide imaging devices with improved image sensor pixels.

### BRIEF DESCRIPTION OF THE DRAWINGS

FIG. 1 is a diagram of an illustrative electronic device having an image sensor and processing circuitry for capturing images using an array of image pixels in accordance with an embodiment.

FIG. 2 is a diagram of an illustrative pixel array and associated readout circuitry for reading out image signals from the pixel array in accordance with an embodiment.

FIG. 3 is a circuit diagram of an illustrative image sensor pixel configured to have high dynamic rang functionalities in accordance with an embodiment.

FIG. 4 is a timing diagram for operating the illustrative image sensor pixel shown in FIG. 3 in accordance with an embodiment.

FIG. 5 is a timing diagram for operating the illustrative image sensor pixel shown in FIG. 4 in accordance with an embodiment.

FIG. 6 is a flow chart of illustrative steps that may be performed by an image sensor to implement high dynamic range functionalities in accordance with an embodiment.

FIG. 7 is a block diagram of a processor system employing the embodiments of FIGS. 1-6 in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

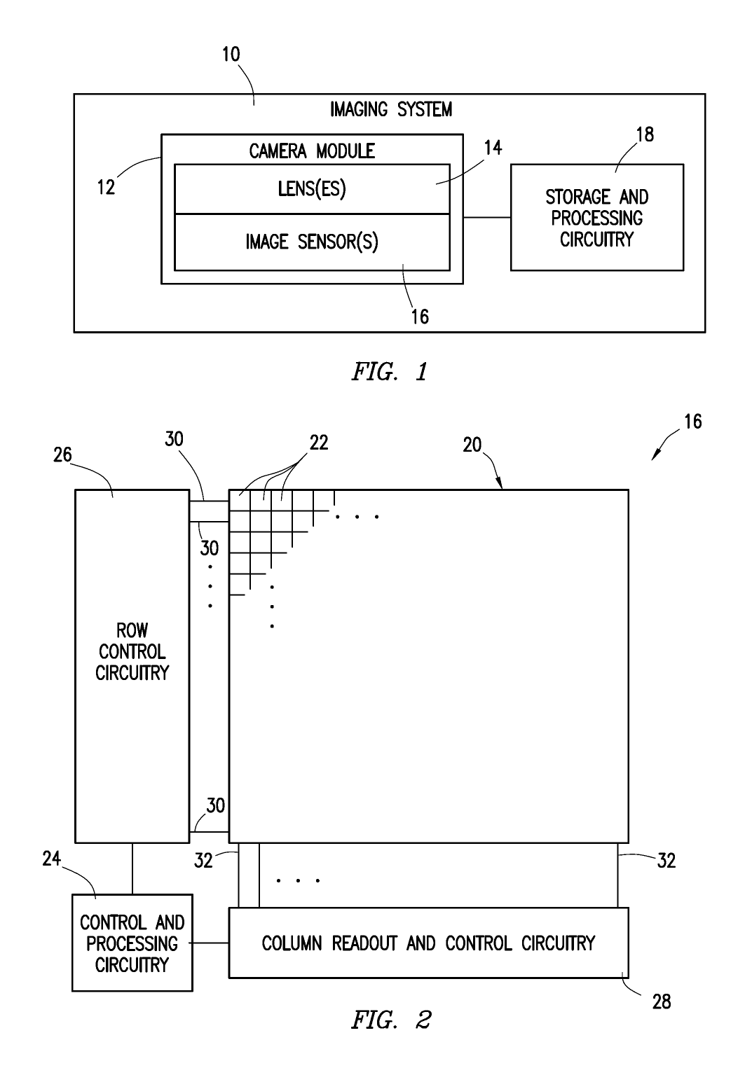

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from the camera module and/or that form part of the camera module (e.g., circuits that form part of an integrated circuit that includes image sensors 16 or an integrated circuit within the module that is associated with image sensors 16). When storage and processing circuitry 18 is included on different integrated circuits (e.g., chips) than those of image sensors 16, the integrated circuits with circuitry 18 may be vertically stacked or packaged with respect to the integrated circuits with image sensors 16. Image data that has been captured by the camera module may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

If desired, image sensor 16 may include an integrated circuit package or other structure in which multiple integrated circuit substrate layers or chips are vertically stacked with respect to each other. In this scenario, one or more of circuitry 26, 28, and 24 may be vertically stacked below array 20 within image sensor 16. If desired, lines 32 and 30 may be formed from vertical conductive via structures (e.g., through-silicon vias or TSVs) and/or horizontal interconnect lines in this scenario.

Image sensors 16 may include one or more arrays 20 of image pixels 22. Image pixels 22 may be formed in a semiconductor substrate using complementary metal-oxide-semiconductor (CMOS) technology or charge-coupled device (CCD) technology or any other suitable photosensitive devices. Image pixels 22 may be frontside illumination (FSI) image pixels or backside illumination (BSI) image pixels. Image pixels 22 may include one or more photosensitive regions. Each photosensitive region in an image pixel 22 may have a photodiode or photodiode region and readout circuitry for the photodiode or photodiode region. Readout circuitry associated with each photodiode or photodiode region in a given photosensitive region may include transfer gates, floating diffusion regions, and reset gates. Isolation regions between photosensitive regions may also be considered part of either or both of the photosensitive regions between which the isolation structure is formed.

As shown in FIG. 2, image sensor 16 may include a pixel array 20 containing image sensor pixels 22 arranged in rows and columns (sometimes referred to herein as image pixels or pixels) and control and processing circuitry 24. Array 20 may contain, for example, hundreds or thousands of rows and columns of image sensor pixels 22. Control circuitry 24 may be coupled to row control circuitry 26 and image readout circuitry 28 (sometimes referred to as column control circuitry, readout circuitry, processing circuitry, or column decoder circuitry). Row control circuitry 26 may receive row addresses from control circuitry 24 and supply corresponding row control signals such as reset, row-select, charge transfer, dual conversion gain, and readout control signals to pixels 22 over row control paths 30. One or more conductive lines such as column lines 32 may be coupled to each column of pixels 22 in array 20. Column lines 32 may be used for reading out image signals from pixels 22 and for supplying bias signals (e.g., bias currents or bias voltages) to pixels 22. If desired, during pixel readout operations, a pixel row in array 20 may be selected using row control circuitry 26 and image signals generated by image pixels 22 in that pixel row can be read out along column lines 32.

Image readout circuitry 28 may receive image signals (e.g., analog pixel values generated by pixels 22) over column lines 32. Image readout circuitry 28 may include sample-and-hold circuitry for sampling and temporarily storing image signals read out from array 20, amplifier circuitry, analog-to-digital conversion (ADC) circuitry, bias circuitry, column memory, latch circuitry for selectively enabling or disabling the column circuitry, or other circuitry that is coupled to one or more columns of pixels in array 20 for operating pixels 22 and for reading out image signals from pixels 22. ADC circuitry in readout circuitry 28 may convert analog pixel values received from array 20 into corresponding digital pixel values (sometimes referred to as digital image data or digital pixel data). Image readout circuitry 28 may supply digital pixel data to control and processing circuitry 24 and/or processor 18 (FIG. 1) over path 25 for pixels in one or more pixel columns.

If desired, image pixels 22 may include one or more photosensitive regions for generating charge in response to image light. Photosensitive regions within image pixels 22 may be arranged in rows and columns on array 20. Pixel array 20 may be provided with a color filter array having multiple color filter elements which allows a single image sensor to sample light of different colors. As an example, image sensor pixels such as the image pixels in array 20 may be provided with a color filter array which allows a single image sensor to sample red, green, and blue (RGB) light using corresponding red, green, and blue image sensor pixels arranged in a Bayer mosaic pattern. The Bayer mosaic pattern consists of a repeating unit cell of two-by-two image pixels, with two green image pixels diagonally opposite one another and adjacent to a red image pixel diagonally opposite to a blue image pixel. In another suitable example, the green pixels in a Bayer pattern are replaced by broadband image pixels having broadband color filter elements (e.g., clear color filter elements, yellow color filter elements, etc.). These examples are merely illustrative and, in general, color filter elements of any desired color and in any desired pattern may be formed over any desired number of image pixels 22.

Image sensor 16 may be configured to support a rolling shutter operation (e.g., pixels 22 may be operated in a rolling shutter mode). For example, the image pixels 22 in array 20 may each include a photodiode, floating diffusion region, and local charge storage region. With a rolling shutter scheme, the photodiodes in the pixels in the image sensor generate image signals sequentially. The image signals may then be transferred to the respective storage regions in each pixel. Data from each storage region of each pixel may then be read out one at a time, for example.

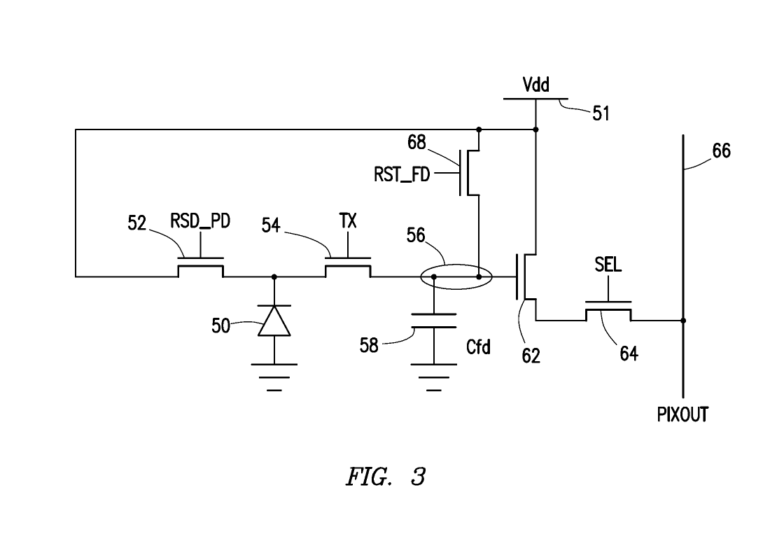

FIG. 3 is a circuit diagram of an illustrative image sensor pixel 22. Pixel may include photosensitive region 50 (e.g., photodiode 50). Photodiode 50 may receive incident light over a period of time (i.e., exposure time) and generate an image signal corresponding to the incident light over the exposure time. In conventional imaging systems, image artifacts may be caused by moving objects, moving or shaking camera, flickering lighting, and objects with changing illumination in an image frame. Such artifacts may include, for example, missing parts of an object, edge color artifacts, and object distortion. Examples of objects with changing illumination include light-emitting diode (LED) traffic signs (which can flicker several hundred times per second) and LED brake lights or headlights of modern cars. Image signals generated with a short integration time and a short exposure time may miss the flickering light (e.g., the blinking light of the LED at a given frequency). However, by spreading the short integration time over a longer exposure time, there is less chance to miss the signal from the flickering light (e.g., pulse light source, LED). Pixel 22 may be designed to reduce artifacts associated flickering lighting by spreading a short integration time over a longer exposure time. To implement flicker mitigation, photodiode 50 may be coupled to voltage source 51 with first supply voltage Vdd through photodiode reset transistor 52 (sometimes referred to herein as anti-blooming transistor 52). When control signal RST_PD is asserted (e.g., pulsed high), photodiode 50 may be reset to first supply voltage Vdd. When control signal RST_PD is deasserted (e.g., pulsed low), photodiode 50 may begin to accumulate charge from incident light.

Subsequent to photodiode reset, a first integration period may begin and photodiode 50 may begin generating and storing an image signal. Pixel 22 may include first transfer transistor 54 and floating diffusion region 56. When the first integration period ends, first transfer transistor 54 may transfer the image signal stored at photodiode 50 to floating diffusion region 56. The time between the beginning and the end of the first integration period may be referred to as a first integration time period. Transfer transistor 54 may include a source terminal, a drain terminal, a gate terminal, and a channel region. Floating diffusion region 56 may be a doped-semiconductor region (e.g., a doped silicon region formed in a silicon substrate by ion implantation, impurity diffusion, or other doping techniques) that has charge storage capabilities shown as capacitor 58 with capacitance Cfd. Photodiode 50 may be connected to a first terminal (e.g., a source or drain terminal) of transistor 54. Floating diffusion region 56 may be connected to a second terminal that opposes the first terminal. As an example, if the first terminal is the source terminal, the second terminal may be the drain terminal, or vice versa. Control signal TX may control both a flow of charge across the channel of transistor 54. When control signal TX is asserted, the image signal stored in photodiode 50 may pass through the channel region of transistor 54 to floating diffusion region 56. Control signal TX may be subsequently deasserted and photodiode 50 may be reset to a supply voltage using control signal RST_PD.

A second integration period may follow the first integration period. Photodiode 50 may generate an image signal corresponding to the second integration period. The image signal from the second integration period may be transferred to floating diffusion region 56 using control signal TX. The image signal from the second integration period may be integrated (e.g., summed or added) with the image signal from the first integration period. The integrated image signal stored at floating diffusion region 56 may be said to have an effective integration time period. The effective integration time period is the summation of the first integration time period and the second integration time period. In general, any number of desired integration processes (e.g., transferring image signals from distinct integration periods to floating diffusion region 56 for summation) may occur. The effective integration period may be generally defined as summation of all of the distinct integration time periods, over which all of the respective individual image signals were generated. After a desired number of integration periods and summation of the corresponding image signals at floating diffusion region 56, control signal TX may be deasserted after adding a last image signal. By breaking up the effective integration period during an image frame into shorter, non-continuous integration periods that span a longer exposure time, image artifacts caused by moving objects, flickering lighting, and objects with changing illumination may be minimized without compromising pixel integration time (i.e., while maintaining the desired total integration time).

Pixel 22 may include readout circuitry that includes source follower transistor 62 and row select transistor 64. Transistor 64 may have a gate that is controlled by row select control signal SEL. When control signal SEL is asserted, transistor 64 is turned on and a corresponding signal PIXOUT (e.g., an output signal having a magnitude that is proportional to the amount of charge at floating diffusion node 56) is passed onto column readout path 66 (sometimes referred to herein as bus line 66). Conversion of incident light into corresponding image signals at photodiode 50 may occur simultaneously with image signal readout, if desired. Pixel 22 may include floating diffusion reset transistor 68. Transistor 68 may have a gate that is controlled by floating diffusion reset control signal RST_FD. Transistor 68 couples floating diffusion region 60 to voltage supply 51 with a supply voltage (e.g., Vdd). When control signal RST_FD is asserted, transistor 68 is turned on and floating diffusion node is reset to the second supply voltage level.

In conventional high dynamic range (HDR) operation, a rolling shutter image sensor will operate with a dual exposure scheme. For example, a first long exposure period will be followed by a second short exposure period. A correlated double sampling readout sequence will then be performed which includes a reset level readout cycle and an image level readout cycle. Each pixel of the rolling shutter image sensor will start a first readout sequence after image signals from the first long exposure period have been generated. Each pixel of the rolling shutter image sensor will then start the second short exposure period, and a second readout sequence after image signals from the second short exposure period have been generated. In order to combine the image signals from both exposure periods, image signals from the first long exposure period needs to be stored in memory circuitry (e.g., a line buffer) until image signals form the second short exposure period are ready to be read out and combined with the image signals from the first long exposure period.

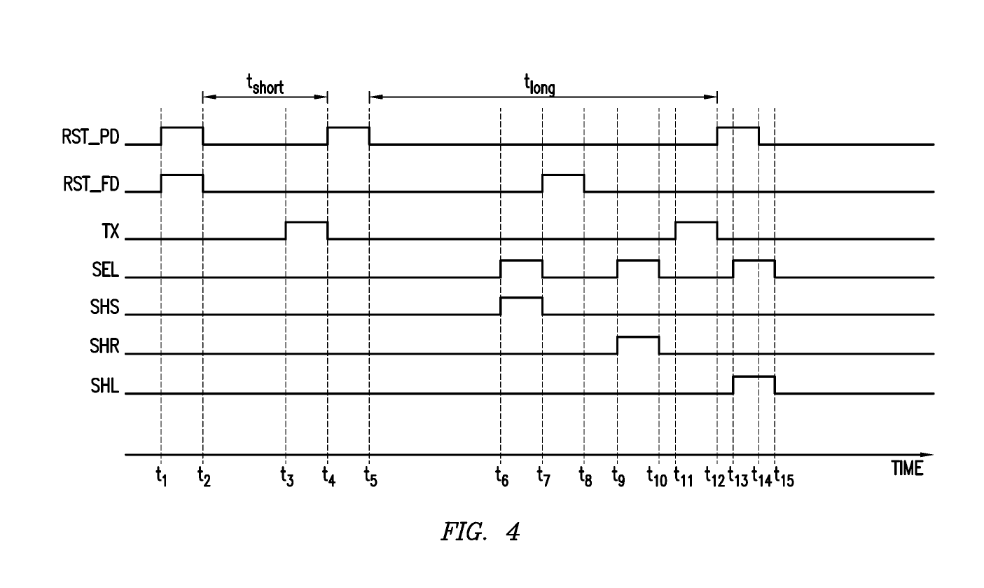

FIG. 4 shows a timing diagram for operating illustrative pixels of the type shown in FIG. 3. The timing diagram shown in FIG. 4 enables pixel 22 to reduce the number of readout sequences, reduce the total number of readout cycles, as well as eliminate the need for memory circuitry to store an image signal from a first exposure period when compared to the conventional HDR sensor described above. At time t₁, pixel 22 may assert control signals RST_PD and RST_FD to reset photodiode 50 and floating diffusion region 56 to the supply voltage level (sometimes referred to herein as reset voltage level) supplied by voltage supply 51. At time t₂, pixel 22 may deassert control signals RST_PD and RST_FD after the resetting of photodiode 50 and floating diffusion region 56 is complete. Photodiode 50 may be reset at any desired time prior to an exposure period. As shown in FIG. 4, an exposure period may include a continuous integration period that overlaps with the exposure period. Since the timing diagram of FIG. 4 does not show a light flicker mitigation mode of operation, an exposure period may sometimes be referred to as an integration period. Floating diffusion region 56 may be reset at any desired time prior to a transfer of image signals to floating diffusion region 56 for storage.

After deasserting control signal RST_PD, at time t₂, a first integration period (e.g., first integration period tₛₕₒᵣₜ) may begin. First integration period tₛₕₒᵣₜ may end at time t₄, when control signal TX is deasserted. When control signal TX is asserted at time t₃, image signals generated at photodiode 50 from first integration period tₛₕₒᵣₜ may be transferred to floating diffusion region 56 for storage. After the image signal from first integration period tₛₕₒᵣₜ (e.g., a short integration image signal) has been transferred, control signal TX may be deasserted at time t₄. Control signal RST_PD may then be asserted again to reset photodiode 50 to the supply voltage level at time t₄. Control signal RST_PD may be deasserted again to begin a second integration period (e.g., second integration period t_{long}). Second integration period t_{long} may end at time t₁₂, when control signal TX is deasserted to transfer an image signal from second integration period t_{long} (e.g., a long integration image signal) to floating diffusion region 56. First integration period tₛₕₒᵣₜ may have a shorter integration time than does second integration period t_{long}. If desired, the first integration period may have a longer integration time than does the second integration period. After the image signals from second integration period have been transferred beginning at time t₁₁, control signal TX may be deasserted at time t₁₂. Control signal RST_PD may then be asserted a last time in the dual exposure scheme to reset photodiode 50 to the supply voltage level at time t₁₂. At time t₁₄, control signal RST_PD may be deasserted to begin collecting an additional set of dual exposure image signals during subsequent short and long integration periods. The short and long integration periods may be from a single exposure cycle. The single exposure cycle may be readout in a single readout sequence (sometimes referred to herein as a single readout cycle). Any desired sets of dual exposure image signals may be generated and read out in this way.

After time t₄ and prior to time t₁₁, the short integration image signal may be read out from floating diffusion node 56 using the readout circuitry. At time t₆, control signal SEL may be asserted to enable transistor 64. When control signal SEL is asserted, transistor 64 is turned on and a corresponding signal PIXOUT (e.g., an output signal having a magnitude that is proportional to the amount of charge at floating diffusion node 56) is passed onto column readout path 66. Output signal PIXOUT corresponding to the short integration image signal may be sent to corresponding sample and hold circuitry by asserting control signal SHS.

Subsequent to completion of readout of the short integration image signal at time t₇, control signal RST_FD may be asserted. When control signal RST_FD is asserted at time t₇, floating diffusion region 56 may be reset to the supply voltage level. Control signal RST_FD may be deasserted at time t₈ after floating diffusion region 56 has been reset. The reset voltage level may be read out from time t₉ to time t₁₀. The supply voltage level may be used for an uncorrelated double sampling readout with the short integration image signal. To readout the supply voltage level, control signal SEL may be asserted at time t₉ and deasserted at time t₁₀ to generate a respective output signal PIXOUT. Output signal PIXOUT corresponding to the supply voltage level may be sent to corresponding sample and hold circuitry by asserting control signal SHR.

The generation of the long integration image signals may end after the readout of the supply voltage level (e.g., time t₁₂ may be after time t₁₀). After the readout of the supply voltage level, the long integration image signal may be transferred to floating diffusion region 56 from time t₁₁ to time t₁₂. The long integration image signal may be read out in a correlated double sampling readout with the supply voltage level readout. To readout the long integration image signal from time t₁₃ to time t₁₅, control signal SEL may be asserted at time t₁₃ and deasserted at time t₁₅ to generate a second respective output signal PIXOUT. Output signal PIXOUT corresponding to the long integration image signal may be sent to corresponding sample and hold circuitry by asserting control signal SHL.

A signal readout sequence occurs from time t₆ to time t₁₅. The signal readout sequence includes a short exposure signal readout, a reset signal readout, and a long exposure signal readout. Since the short exposure signal is temporarily stored at floating diffusion node, no memory circuitry (e.g., a line buffer) is needed to store the first exposure signal in this dual exposure scheme. Moreover, only a single signal readout sequence is needed for each set of dual exposure signals, and fewer reset level readout cycles is needed, thereby increasing the speed of operating pixel 22. Additionally, Pixel 22 is configured to operate with double sampling readout for both the short and long exposure signal readouts. The long exposure image signal, which is used in low light conditions, may be more sensitive to reset level noise than the short exposure image signal. By sampling the long exposure image signal after sampling the reset level noise, the long exposure image signal will have a correlated double sampling readout.

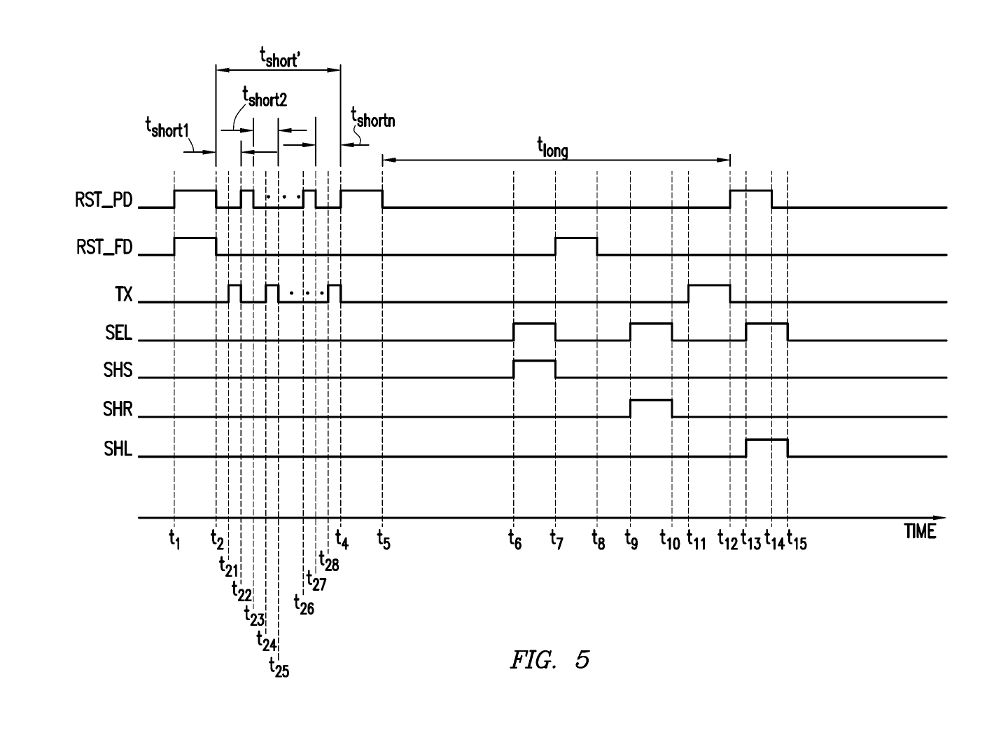

FIG. 5 shows a timing diagram for operating illustrative pixels of the type shown in FIG. 3 to additionally reduce image artifacts by mitigating light flickering. In applying light flicker mitigation, an exposure period may include a plurality of continuous integration periods that are spread out across the exposure period. This results in an effective discontinuous integration period that overlaps a longer exposure period. FIG. 5 includes reference numerals previously described in FIG. 4. In order to avoid unnecessarily obscuring the present embodiment of FIG. 5, the reference numerals refer to the descriptions in FIG. 4 unless otherwise stated.

Instead of a single continuous short integration time period as shown in FIG. 4, FIG. 5 shows a discontinuous effective integration time period, which includes a plurality of short integration time periods. The plurality of short integration time periods are summed to generate effective short integration time period tₛₕₒᵣₜ. Effective short integration time period tₛₕₒᵣₜ may include distinct integration periods Tₛₕₒᵣₜ₁, Tₛₕₒᵣₜ₂, . . . , and Tₛₕₒᵣₜₙ. Image signals generated during the distinct integration periods may be continually summed at floating diffusion region 56 by asserting control signal TX for transistor 54. More specifically, first integration period Tₛₕₒᵣₜ₁ may begin after the deassertion of control signal RST_PD at time t₂ and may end when control signal TX is deasserted at time t₂₂. When control signal TX is asserted at time t₂₁, the image signal generated at photodiode 50 may be transferred to floating diffusion region 56. When control signal TX is deasserted at time t₂₂, control signal RST_PD may be asserted to reset photodiode 50 to the supply voltage level at time t₂₂.

When control signal RST_PD is deasserted at time t₂₃, second integration period Tₛₕₒᵣₜ₂ may begin. Second integration period Tₛₕₒᵣₜ₂ may end at time t₂₅. When control signal TX is asserted at time t₂₄, the image signal generated at photodiode 50 may be transferred to floating diffusion region 56 and summed with the previous image signal from first integration period Tₛₕₒᵣₜ₁. When control signal TX is deasserted at time t₂₅, photodiode 50 may be reset to the supply voltage level again, after which a third integration period Tₛₕₒᵣₜ₃ (not shown) may be begin. In general, an assertion of control signal RST_PD at time t₂₆ and subsequent deassertion of control signal RST_PD at time t₂₇ may begin generation of image signals for nth integration period Tₛₕₒᵣₜₙ. The nth integration period Tₛₕₒᵣₜₙ may end at the subsequent deassertion of the control signal TX. At the end of nth integration period Tₛₕₒᵣₜₙ (e.g., at time t₄), the image signal from nth integration period Tₛₕₒᵣₜₙ may be transferred to floating diffusion region 56 and summed with the image signals from previous integration periods. Any desired number of integration periods (n) may be used. Summed image signals at floating diffusion region 56 may then be read out as described in FIG. 4. In this scenario, the summed image signals may have an effective integration time period spanning a first exposure period. The first exposure period may be shorter than second exposure period t_{long} as shown in FIG. 4.

By breaking up the effective integration period during an image frame into shorter, non-continuous integration periods that span a longer exposure time, image artifacts caused by moving objects, flickering lighting, and objects with changing illumination may be minimized without compromising pixel integration time (i.e., while maintaining the desired total integration time). In addition, FIG. 5 has benefits of FIG. 4 in that no memory circuitry (e.g., a line buffer) is needed to store the first exposure signal in this dual exposure scheme. Moreover, only a single signal readout sequence is needed for each set of dual exposure signals, and fewer reset level readout cycles are needed, thereby increasing the speed of operating pixel 22. Additionally, both image signal readouts will be double sampling readouts. The long exposure image signal, which is more sensitive to noise, will have a correlated double sampling readout.

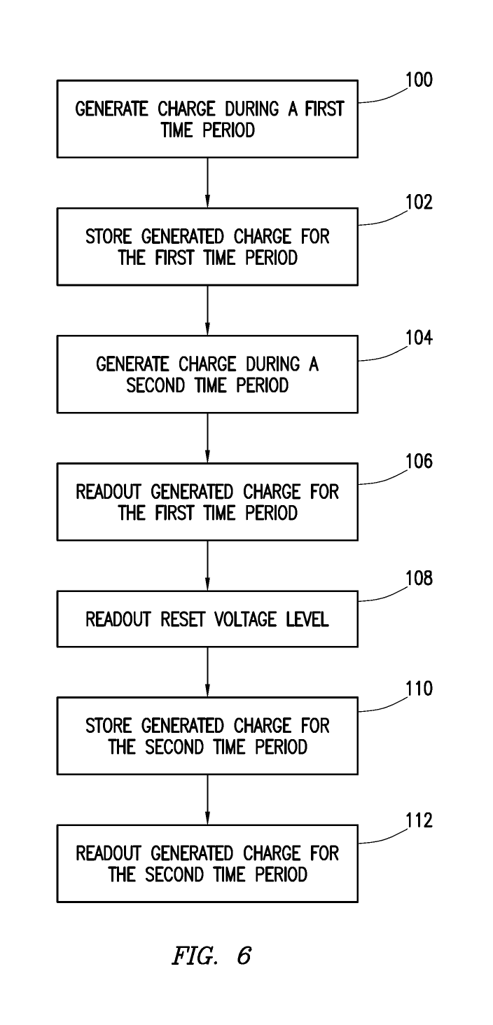

FIG. 6 shows a flow chart with illustrative steps for operating image sensor pixels of the type shown in FIG. 3 in a high dynamic range mode. At step 100, photodiode 50 may generate image signals (e.g., charge) corresponding to incident light for a first time period (e.g., a first exposure period). The first time period may be a shorter exposure period compared to a subsequent second time period. The first exposure period may include a plurality of continuous integration periods. The image signals from the continuous integration periods may be summed to generate an effective image signal for the first exposure period. In a separate example, the first exposure period may include a single continuous integration period. The image signal for the first exposure period may sometimes be referred to herein as first exposure image signal.

At step 102, the first exposure image signal may be stored at floating diffusion region 56. When the image signals from the plurality of continuous integration time periods are summed to generate the effective image signal for the first exposure period, the summation may occur at floating diffusion region 56. Alternatively, pixel 22 may include an additional charge storage region (e.g., capacitor, storage diode, storage gate). The separate image signals from the respective integration time periods may be summed at the additional charge storage region before being transferred to floating diffusion region 56 for subsequent readout.

At step 104, photodiode 50 may generate image signals (e.g., charge) corresponding to incident light for a second time period (e.g., a second exposure period). The second time period may be a longer exposure period compared to the first time period. Alternatively, the second time period may be a shorter exposure period or similar in length compared to the first time period. If pixel 22 includes the additional charge storage region described in in connection with step 102, the second exposure period may also include a second set of continuous integration periods that make up a discontinuous integration period. The image signals from the respective continuous integration periods may be summed at the additional charge storage region. Alternatively, the second exposure period may include a single continuous integration period. The image signal for the second exposure period may sometimes be referred to herein as second exposure image signal.

At step 106, the first exposure image signal stored at floating diffusion region 56 may be read out using readout circuitry (e.g., source follower transistor, row select transistor).

At step 108, floating diffusion region 56 may be reset to the reset voltage level (e.g., supply voltage level). The reset voltage level may be read out using readout circuitry. The reset voltage level may provide a reference for a double sampling readout.

At step 110, the second exposure image signal may be transferred to floating diffusion region 56 to be temporarily stored before readout.

At step 112, the second exposure image signal stored at floating diffusion region 56 may be readout using readout circuitry. Using the reset voltage level, the readout of the second exposure image signal may be a correlated double sampling readout.

In an alternative embodiment, dual gain conversion may be implemented in combination with the methods shown in FIGS. 3-6. In this embodiment, step 108 may be omitted. The first exposure image signal stored at floating diffusion 56 may be read out at step 106. Then, the second exposure image signal may be transferred to floating diffusion region 56 at step 110, immediately following step 106. In this scenario, a low light signal for HDR operation may be the image signal stored at floating diffusion region 56 following step 110. In other words, the low light signal may be the difference between the first exposure image signal and the second exposure image signal. The high light signal for HDR operation may be the image signal stored at floating diffusion region 56 following step 104. In other words, the high light signal may be the difference between the first exposure image signal and a fixed reference or externally store frame. This method of operation removes a readout cycle for the reset voltage level, which decreases power consumption and increase the speed of the readout sequence. Alternatively, if the first exposure image signal is beyond a desired threshold, the second exposure image signal may be ignored.

In an alternative embodiment, charge overflow capabilities may be implemented in combination with the methods shown in FIGS. 3-6. In this embodiment, the first exposure image signal may contain overflow charges. In such a scenario, floating diffusion region 56 may have a larger charge storage capacity than photodiode 50. The charges in excess to the storage capacity of photodiode 50 may be transferred to floating diffusion region 56. In another configuration, a transistor may impose an overflow barrier for charges in photodiode 50. The charges in excess of the overflow barrier may then over flow to floating diffusion region 56. The overflow charges stored at floating diffusion region 56 may be a low gain signal. The charges remaining at photodiode 50 may be a high gain signal. In such a scenario, steps 102 and 104 may be skipped. Immediately following step 100, the high gain signal may be stored at photodiode 50 and the low gain signal may be stored at floating diffusion region. The low gain signal may be ready for read out at step 106 and proceed with steps 108, 110, and 112.

Alternatively, following the generation of the low and high gain signals, the subsequent steps 104 and 106 may proceed as normal. In this alternative scenario, the low gain signal may be stored at a charge storage structure (sometimes referred to as a charge storage element) in addition to floating diffusion region 56, which may be used for storage of the second exposure image signal. An additional readout step may be needed to readout both the low and high gain signals of the first exposure image signal.

In yet another embodiment, pixel 22 may include an additional charge storage structure (e.g., a storage gate, a capacitor) to support a third exposure time period implemented in combination with the methods shown in FIGS. 3-6. In such an example, the first exposure image signal may be stored at the additional charge storage structure. The second exposure image signal may be stored at floating diffusion region 56, ready to be readout as the image signals from the third exposure period is being generated. If the additional charge storage structure is implemented without a third exposure time period, the first and second exposure image signals may both be readout in a correlated double sampling readout process. If desired, pixel 22 may include any number of additional charge storage structures to support any number of exposure periods. In a separate example, if desired, the first exposure image signal may be transferred and readout in a global shutter operating mode.

The order of the short and long exposure periods in FIGS. 4-6 is merely illustrative. If desired, the long exposure period may occur before the short exposure period. The long exposure period may be stored at a charge storage region (e.g., floating diffusion 56) until the short exposure period has occurred. If desired, any number of exposure periods with variable lengths may be used to generate a corresponding number of image signals that may be stored in a number of charge storage regions in pixel 22.

In general, the methods described in FIGS. 4-6 may be used in a pixel with any desired structure. The example of pixel 22 in FIG. 3 is merely illustrative, and the pixel may have any desired layout. Any pixel with a photosensitive region, a charge storage region, and a transfer transistor may implement the operation methods described in connection with FIGS. 4-6.

Although not shown in FIG. 3, the methods of FIGS. 4-6 may be applied to a pixel with a stacked wafer arrangement (sometimes referred to as stacked-chip configuration). If desired, image sensor pixel 22 may include an integrated circuit package or other structure in which multiple integrated circuit substrate layers or chips are vertically stacked with respect to each other. In this scenario, one or more of the components of pixel 22 (e.g., floating diffusion region 56, voltage supply 51, photodiode 50, etc.) may be vertically stacked above or below one another within pixel 22. If desired, signal lines (e.g., data lines, bus lines) may be formed from vertical conductive via structures (e.g., through-silicon vias or TSVs) and/or horizontal interconnect lines in this scenario. For example, a metal interconnect layer may couple the floating diffusion region to the source follower transistor. In a separate example, a metal interconnect layer may couple the transfer transistor to the floating diffusion region. In yet another sample, a metal interconnect layer may couple the anti-blooming transistor and/or the floating diffusion reset transistor to the voltage supply. When a pixel is formed in a stacked wafer arrangement, individual wafers may be specialized to more efficiently perform its particular function. As an example, if photosensitive elements are included in a first wafer of an image sensor, additional components of the pixels may be moved to a second wafer. Moving pixel components to the second wafer allows a ratio between active area and inactive area in the first wafer to increase, leading to greater light gathering capabilities.

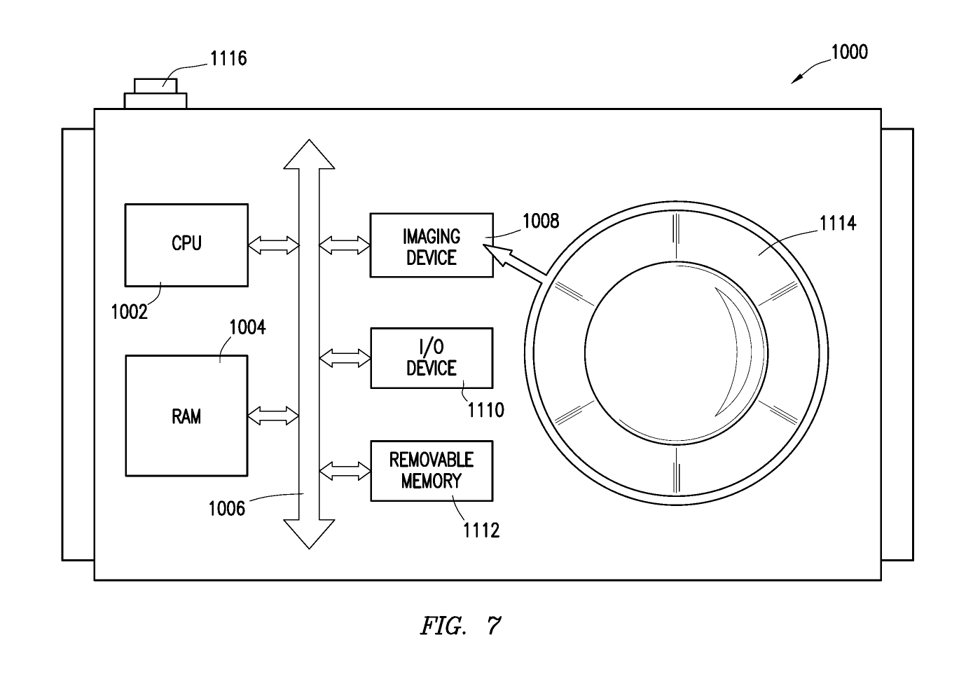

FIG. 7 is a simplified diagram of an illustrative processor system 1000, such as a digital camera, which includes an imaging device 1008 (e.g., the camera module of FIG. 1) employing an imager having pixels as described above in connection with FIGS. 1-6. Without being limiting, such a system could include a computer system, still or video camera system, scanner, machine vision system, vehicle navigation system, video phone, surveillance system, auto focus system, star tracker system, motion detection system, image stabilization system, and other systems employing an imaging device.

Processor system 1000, for example a digital still or video camera system, generally includes a lens 1114 for focusing an image onto one or more pixel arrays in imaging device 1008 when a shutter release button 1116 is pressed and a central processing unit (CPU) 1002 such as a microprocessor which controls camera and one or more image flow functions. Processing unit 1102 can communicate with one or more input-output (I/O) devices 1110 over a system bus 1006. Imaging device 1008 may also communicate with CPU 1002 over bus 1006. System 1000 may also include random access memory (RAM) 1004 and can optionally include removable memory 1112, such as flash memory, which can also communicate with CPU 1002 over the bus 1006. Imaging device 1008 may be combined with the CPU, with or without memory storage on a single integrated circuit or on a different chip. Although bus 1006 is illustrated as a single bus, it may be one or more busses, bridges or other communication paths used to interconnect system components of system 1000.

Various embodiments have been described illustrating systems and methods for generating images using image sensor pixels having high dynamic range functionalities.

The image sensor pixel may include a photosensitive region (e.g., a photodiode), a charge storage region (e.g., a floating diffusion region), and a transfer transistor that couples the photosensitive region to the charge storage region. The image sensor pixel may further include readout circuitry (e.g., a source follower transistor, a row select transistor, etc.). The photosensitive region may generate a first image signal in response to incident light during a first exposure period. The transfer transistor may transfer the first image signal to the charge storage region. The photosensitive region may generate a second image signal in response to incident light during a second exposure period. While generating the second image signal, the readout circuitry may perform readout operations on the first image signal stored at the charge storage region. The readout operations on the first image signal may be a double sampling readout.

Subsequent to the readout of the first image signal, the charge storage region may be reset to a reset voltage level supplied by a reset voltage supply. While generating the second image signal, the readout circuitry may perform readout operations on the reset voltage level stored at the charge storage region. Then transfer transistor may then transfer the second image signal to the charge storage region. The readout circuitry may perform readout operations on the second image signal. The readout operations on the second image signal may be a correlated double sampling readout.

In an alternative embodiment, the photosensitive region may generate image signals in response to light during an effective discontinuous integration period that spans an exposure period. The discontinuous integration period may include a plurality of continuous integration periods during each of which, a corresponding image signal is generated by the photosensitive region. The plurality of continuous integration periods may be implemented by alternatingly asserting the transfer transistor and a photodiode reset transistor. The charge storage region may sum the image signals from the plurality of continuous integration periods to generate the first image signal.

In an alternative embodiment, the image sensor pixel may include an additional charge storage element (e.g., capacitor, storage diode, storage gate, etc.). The additional charge storage element may store a third image signal generated during a third corresponding exposure period. The additional charge storage element may also store the first image signal, such that the readout operations on the first image signal may be a correlated double sampling readout. Additionally, the transfer transistor may impose an overflow barrier. A portion of the first image signal stored at the photosensitive area may be above the overflow barrier. The portion of the first image signal may be transferred to the additional charge storage element. The portion of the first image signal may also be transferred to the charge storage region, if desired.

The foregoing is merely illustrative of the principles of this invention and various modifications can be made by those skilled in the art without departing from the scope and spirit of the invention. The foregoing embodiments may be implemented individually or in any combination.

1. A method of operating a rolling shutter image sensor pixel that includes a photosensitive region, a transfer transistor, readout circuitry, and a charge storage region, the method comprising:
using the photosensitive region, generating a first amount of charge in response to incident light during a first time period;
using the transfer transistor, transferring the first amount of charge from the photosensitive region to the charge storage region;
using the photosensitive region, generating a second amount of charge in response to incident light during a second time period;
while generating the second amount of charge, storing the first amount of charge at the charge storage region; and
during a single readout cycle, transferring the first amount of charge and the second amount of charge onto a pixel readout path by asserting a row select transistor in the readout circuitry, wherein transferring the first amount of charge onto the pixel readout path comprises transferring the first amount of charge onto the pixel readout path while generating the second amount of charge.

2. The method defined in claim 1, wherein the first time period is shorter than the second time period.

3. The method defined in claim 1, further comprising:
performing a double sampling readout operation on the first amount of charge.

4. The method defined in claim 1, further comprising:
performing a double sampling readout operation on the second amount of charge.

5. The method defined in claim 1, wherein the image sensor pixel further includes a reset transistor and wherein generating the first amount of charge comprises generating a plurality of charges during a plurality of integration time periods using the reset transistor and the transfer transistor.

6. The method defined in claim 1, wherein the image sensor pixel further includes a second reset transistor, the method further comprising:
asserting the second reset transistor to reset the charge storage region to a reset voltage level; and
during the single readout cycle, sampling the reset voltage level using the readout circuitry.

7. The method defined in claim 1, wherein the image sensor pixel further includes a charge storage element, the method further comprising:
using the charge storage element, storing a portion of the first amount of charge.

8. The method defined in claim 1, wherein the image sensor pixel further includes at least one charge storage element, the method further comprising:
using the photosensitive region, generating a third amount of charge in response to incident light; and
using the charge storage element, storing the third amount of charge.

9. The method defined in claim 1, wherein the image sensor pixel further includes a charge storage element, the method further comprising:
with the charge storage element, storing the first amount of charge; and
performing a double sampling readout on the first amount of charge.

10. The method defined in claim 1, wherein the charge storage region comprises a floating diffusion region.

11. A method of operating a rolling shutter image sensor pixel that includes a photodiode, a transfer transistor, readout circuitry, and a charge storage region, the method comprising:
with the photodiode, generating a first image signal in response to light during a first exposure period;
using the transfer transistor, transferring the first image signal to the charge storage region;
using the readout circuitry, performing readout operations on the first image signal during a readout cycle; and
while performing readout operations on the first image signal, generating a second image signal in response to light during a second exposure period, wherein the second image signal is read out during the readout cycle.

12. The method defined in claim 11, wherein the image sensor pixel further includes a reset voltage source with a reset voltage level and a reset transistor coupled to the reset voltage source, the method further comprising:
asserting the reset transistor to reset the charge storage region to the reset voltage level.

13. The method defined in claim 12, further comprising:
using the readout circuitry, performing readout operations on the second image signal during the readout cycle.

14. The method defined in claim 13, further comprising:
using the readout circuitry, performing readout operations on the reset voltage level before performing readout operations on the second image signal during the readout cycle.

15. The method defined in claim 14, wherein performing readout operations on the reset voltage level comprises performing readout operations on the reset voltage level after performing readout operations on the first image signal.

16. The method defined in claim 15, wherein performing readout operations on the reset voltage level comprises performing readout operations on the reset voltage level while the photodiode generates the second image signal.

17. The method defined in claim 16, wherein the image sensor pixel further includes a photodiode reset transistor, wherein generating the first image signal comprises:
generating image signals by alternatingly asserting the reset transistor and the transfer transistor; and
at the charge storage region, summing the image signals to generate the first image signal.

18. A system, comprising:
a central processing unit;
memory;
a lens;
input-output circuitry; and
a rolling shutter image pixel, wherein the rolling shutter image pixel comprises:
a photosensitive region that is configured to generate image signals in response to light during a first discontinuous integration period, wherein the first discontinuous integration period comprises a plurality of continuous integration periods during each of which a corresponding image signal is generated by the photosensitive region and wherein the photosensitive region is configured to generate a second image signal in response to light during a second continuous integration period;
a floating diffusion region that is configured to sum the corresponding image signals from the plurality of continuous integration periods to generate a first image signal, wherein the first and second image signals are sampled from the rolling shutter image pixel during a single readout sequence; and
readout circuitry that performs readout operations on the first image signal while the photosensitive region generates the second image signal and that subsequently performs readout operations on the second image signal during the single readout sequence.

19. The system defined in claim 18, wherein the readout circuitry is configured to perform readout operations on a reset voltage level during the single readout sequence, while the photosensitive region generates the second image signal.

20. The system defined in claim 18, wherein the readout operations on the first image signal comprise a double sampling readout and wherein the readout operations on the second image signal comprise a double sampling readout.
